(19) United States
(12) Patent Application Publication
(10) Pub. No.: US 2026/0293862 A1
(43) Pub. Date: Oct. 1, 2026

(54) SUBSTRATE, DEVICE AND METHOD OF GROWING CORALS

(71) Applicant: V-CORALS LTD., Eilat (IL)

(72) Inventors: Shachar DAMARI, Hod HaSharon (IL); Elad SHIFMAN, Gedera (IL)

(21) Appl. No.: 19/477,852

(22) PCT Filed: Apr. 21, 2024
(86) PCT No.: PCT/IL2024/050402

§ 371 Date: Oct. 23, 2025

(30) Foreign Application Priority Data
Apr. 23, 2023 (IL) 302366

(51) Int. Cl. A01K 61/73

(52) U.S. Cl. CPC A01K 61/73

(57) ABSTRACT

A substrate, device and method for growing coral fragments is disclosed. The substrate may include a flexible polymeric film, made with one or more openings and is configured to inhibit the growth of at least a first type of algae, while allowing growth of at least a second type of algae. A device may include a base comprising a frame portion, and a support portion and a substrate comprising a flexible polymeric film, detachably connectable to the base. The frame portion may be configured to accommodate the substrate, and the support portion may include a plurality of legs, for supporting the frame and the accommodated substrate. A method for growing coral fragments using the substrate and device is further disclosed.

### CROSS REFERENCE TO RELATED APPLICATIONS

This present patent application claims the benefit of priority from IL Patent Application No. 302366, filed on Apr. 23, 2023 and entitled “SUBSTRATE, DEVICE AND METHOD OF GROWING CORALS”, which is incorporated in its entirety by reference.

### BACKGROUND OF THE INVENTION

The present invention relates generally to the technological field of coral aquaculture, also known as coral farming or coral gardening. More specifically, the present invention relates to asexual reproduction and propagation of corals by fragmenting donor ones into new colonies.

As known in the art, cultivation of corals for commercial purposes or coral reef restoration has gained popularity in recent decades. Aquaculture is showing promise as a potentially effective tool for restoring coral reefs, which have been dramatically declining around the world.

Coral fragmentation (or coral “fragging”) is the act of cutting or breaking an established coral colony (also called “mother” colony) into smaller colonies (called “daughter” colonies, “coral fragments” or “frags”) and securing them to an artificial substrate. Coral fragments are further healed and grown in nurseries (growth containers filled with seawater of desired composition, equipped with a required lighting system and water flow controlling system etc.) and replanted on the reef thereafter.

After being cut from the “mother” colony, coral fragments are usually attached to a suitable substrate, such as special ceramic plate or a piece of a live rock. Live rocks, since they look natural, are commonly used for further arranging corals in aquariums and creating unique coral environments for display. For other purposes, e.g., propagating, organizing, and selling, ceramic plates are typically used. As known in the art, such ceramic plates are manufactured in various shapes, such as square tiles, round discs, and plugs. Plugs (also called “frag plugs”) have shape of a round or square base with a flat surface from the top side for positioning coral fragments, and a rod in the bottom, which is used for placing the plug in the holder, which, in turn, is fixed inside the aquarium and is configured to keep the plug with the attached coral fragment under the water in the desired place (e.g. the place where the required light and water flow conditions are maintained).

As known in the art, one of the important aspects of successful coral propagation is the effective control of the presence and population of various algae in growth containers. In particular, the following types of algae should be controlled.

Diatoms (or Bacillariophyta) are an undesirable type of algae that form brown algae layers which traditionally appear in a newly set-up growth container (or tank) after about one to three weeks. These algae coat almost every surface in the tank, including commonly used types of substrates (e.g., ceramic plates and plugs), technical equipment, plant leaves and decoration. They can form very stubborn brown coats on the glass of low-light tanks. The class of Diatoms contains many genera and species. Aquarium keepers often call them “brown algae” due to their color.

The brown algae are further replaced by another undesirable type-“green algae” (or Bryopsis plumosa). It is colored bright green and has a soft, silky texture. These algae also easily cover various surfaces in the tank, including traditionally used types of substrates (e.g., ceramic plates and plugs).

Both Bacillariophyta and Bryopsis plumosa are usually harmless under normal circumstances, however they tend to slow down the process of healing and growing new coral frags by competing with other, more “useful” types of algae for the population area and the consumption of the elements from water.

Coralline Algae is a type of red algae that is considered to be a desirable type of algae to have in a saltwater aquarium. Its growth is an indication of a properly matured seawater tank. Coralline algae acts as a food source, structural support system and environmental protector for saltwater, and even freshwater, reef systems. It is commonly introduced into an aquarium by placing live rock thereinto.

Coralline Algae exists in 2 forms: Geniculate or (articulated) corallines and Nongeniculate or (nonarticulated) corallines.

Geniculate corallines include branching, tree-like organisms which are flexible by having noncalcified sections.

Nongeniculate corallines are typical encrusting and plating reef tank variety. They are often very slow growing and will grow on live rock, coral skeletons, shells, glass, plastics, and other algae. Matured coralline crusts may produce knobby protuberances which provide microhabitats for many invertebrates. Other non-articulated corallines produce chemicals which promote the settlement of the larvae of certain invertebrates.

There are various standard methods that can help to reduce or control growth of undesired algae known in the art (such as: removing excess nutrients (DOCs) through protein skimming, reducing nitrate and phosphate content, increasing or decreasing the water flow or circulation, applying blackouts etc.), however, known methods are often burdensome and may damage desired type of algae together with undesired ones, as well as affect growth of coral frags.

### SUMMARY OF THE INVENTION

Accordingly, there is a need for a solution which would provide an improvement of the technological field of coral aquaculture by simplifying and increasing efficiency of the process of controlling presence and population of algae in the coral propagation aquarium, thereby reducing time required for healing and growing new coral fragments.

In the general aspect, the invention may be directed to a substrate for growing corals. The substrate may include a flexible polymeric film, wherein said film may be made with one or more openings and may be configured to inhibit the growth of at least a first type of algae, while allowing growth of at least a second type of algae.

In another general aspect, the invention may be directed to a coral growing device The device may include a base in turn including a frame portion, and a support portion; and a substrate, which may be detachably connectable to the base, wherein the frame portion may be configured to accommodate the substrate, and wherein the support portion may include a plurality of legs, for supporting the frame and the accommodated substrate.

In yet another general aspect, the invention may be directed to a method of growing corals. Said method may include inhabiting at least one coral fragment on a flexible polymeric film configured to inhibit the growth of at least a first type of algae, while allowing growth of at least a second type of algae; inserting the film into a growth container; and providing a controlled water flow to circulate the water in the growth container, to allow growth of the at least one coral fragment.

In some embodiments, the substrate may be detachably connectable to a support.

In some embodiments, the film may have at least 5% open area, or, more specifically, may have 5-50% open area, or, yet more specifically, may have 10-40% open area.

In some embodiments, the film may be made of a polymer selected from a list consisting of: acrylonitrile butadiene styrene (ABS); polystyrene (PS); polypropylene (PP); polyethylene (PE); polyethylene terephthalate (PET); polyethylene terephthalate glycol (PET-G); polymethyl methacrylate (PMMA); and silicon.

In some embodiments, the thickness of the film may be between 0.01 to 10 mm.

In some embodiments, the film may have a surface roughness of between 0.0015 to 0.007 mm.

In some embodiments, the base may be configured to allow passage of fluids from one side of the film to another side of the film, through the one or more openings in the film.

In some embodiments, the coral growing device may further include at least one connector for connecting the device to at least one other coral growing device.

In some embodiments, the coral growing device may further include a weight element connected to the base, wherein said weight element may have weight sufficient to prevent buoyancy of the coral growing device when immersed in seawater.

In some embodiments, the weight element may be connected to the base so as to allow passage of fluids from one side of the film to another side of the film, through the one or more openings in the film.

In some embodiments, providing the controlled water flow may include providing a water flow via one or more openings in the film.

In some embodiments, inhabiting the at least one coral fragment on the film may include fixing the at least one coral fragment on the film using an adhesive substance.

In some embodiments, the adhesive substance may be a cyanoacrylate-based adhesive substance.

In some embodiments, the method may further include harvesting the at least one coral fragment by fully detaching the at least one coral fragment from the film without leaving any portion of the at least one coral fragment on the film.

In some embodiments, the first type of algae may be at least one of Bryopsis plumosa and Bacillariophyta.

In some embodiments, the second type of algae may be Coralline algae.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A is an isometric view of a coral growing device with a coral fragment fixed thereon, according to some embodiments;

FIG. 1B is an isometric view of a coral growing device, according to some embodiments;

FIG. 2A is an isometric view of a substrate for growing coral fragments, according to some embodiments;

FIG. 2B is a top view of a substrate for growing coral fragments, according to some embodiments;

FIG. 3A is an isometric view of a base of the coral growing device, according to some embodiments;

FIG. 3B is a top view of the base of the coral growing device, according to some embodiments;

FIG. 3C is a side view of the base of the coral growing device, according to some embodiments;

FIG. 4A is an isometric view of the coral growing device including a weight element connected to the base, according to some embodiments;

FIG. 4B is a side view of the coral growing device including a weight element connected to the base, according to some embodiments;

FIG. 4C is an isometric view of the weight element of the coral growing device, according to some embodiments;

FIG. 5A is an isometric view of a coral frag rack, configured to accommodate the coral growing devices of various sizes, according to some embodiments;

FIG. 5B is an isometric view of the coral frag rack with bases of coral growing devices of various sizes attached thereto, according to some embodiments;

FIG. 6 is a flow diagram, depicting a method of growing corals, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

As can be seen, the indicated problem of the prior art is addressed herein by providing a specific substrate which is configured to inhibit the growth of the at least a first type of algae, while allowing growth of the at least a second type of algae. Flexible polymeric film, as claimed herein, is a material characterized by having a very low surface roughness (e.g., between 0.0015 to 0.007 mm) which is too low for certain types of algae (e.g., Bryopsis plumosa and Bacillariophyta) to attach to and grow thereon. However, as was approved by conducting numerous tests, said surface roughness is sufficient for other types of algae (e.g., Coralline algae) to attach to and grow thereon. Therefore, the process of controlling algae presence and population may be more effective and simple, and the time required for healing and growing new coral fragments may be reduced.

Furthermore, by having one or more openings in the film, which allow passage of fluids from one side of the film to another side of the film, the required water circulation around the attached coral fragment is achieved, thereby further providing favorable conditions (e.g., keeping the desired pH level) for healing and growing the coral frag.

Unless explicitly stated, the method embodiments described herein are not constrained to a particular order in time or chronological sequence. Additionally, some of the described method elements may be skipped, or they may be repeated, during a sequence of operations of a method.

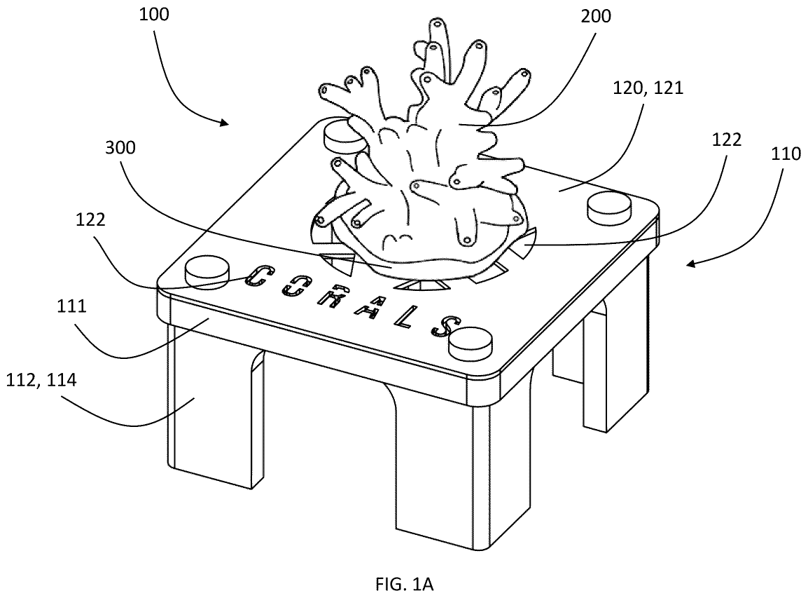

Reference is now made to FIGS. 1A and 1B, depicting an isometric view of a coral growing device 100 with coral fragment 200 fixed thereon and without coral fragment 200, respectively, according to some embodiments.

In some embodiments, the coral growing device 100 may include base 110. Base 110 may include frame portion 111 and support portion 112. In the context of the present invention terms “base” and “support” are used interchangeably.

In some embodiments, the coral growing device 100 may further include substrate 120 for growing coral fragments (e.g., coral fragment 200), detachably connectable to base 110. Frame portion 111, in turn, may be configured to accommodate substrate 120. In some embodiments, substrate 120 may include flexible polymeric film 121. In some embodiments, film 121 may be made with openings 122.

In some embodiments, coral fragment 200 may be inhabited on film 121. E.g., coral fragment 200 may be fixed on film 121 by adhesive substance 300.

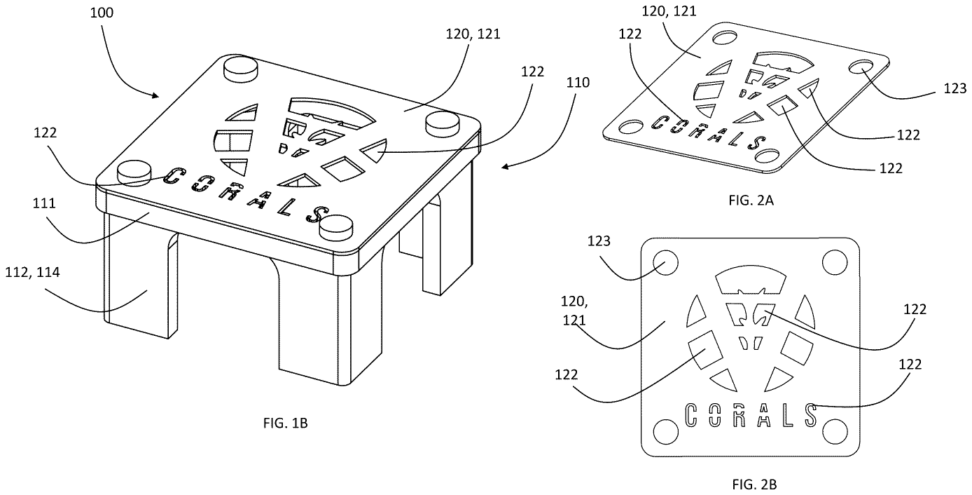

Reference is now made to FIGS. 2A and 2B, depicting an isometric view and a top view of substrate 120 for growing coral fragments (e.g., coral fragment 200), respectively.

It shall be understood that openings 122 may be made in various sizes, shapes and locations. E.g., in the depicted embodiment, openings 122 made in the form of company logo and name. It shall be understood that the present invention is not limited to any specific size, shape, or location of openings 122, as long as they allow passage of fluids from one side of film 121 to another side of film 121.

In some embodiments, substrate 120 may include single layer, thereby including only film 121. In alternative embodiments, substrate 120 may include a plurality of layers, wherein film 121 may be the top layer (e.g., the layer for inhabiting coral fragment 200 thereon). In some embodiments, other layers may also be flexible. It shall be understood that, in the embodiments where substrate 120 may have a plurality of layers, each layer may have openings, corresponding to openings 122 of film 121, thereby allowing passage of fluids from one side of substrate 120 to another side of substrate 120.

In some embodiments, film 121 may be made of a polymer selected from a list consisting of: acrylonitrile butadiene styrene (ABS); polystyrene (PS); polypropylene (PP); polyethylene (PE); polyethylene terephthalate (PET); polyethylene terephthalate glycol (PET-G); polymethyl methacrylate (PMMA); and silicon.

Film 121 may be configured to inhibit the growth of at least a first type of algae (e.g., Bryopsis plumosa and Bacillariophyta), while allowing growth of at least a second type of algae (e.g., Coralline algae). In particular, in some embodiments, film 121 may have surface roughness of between 0.0015 to 0.007 mm, which is such as to allow said second type of algae to attach and grow thereon, while not allowing said first type of algae to attach and grow thereon.

In some embodiments, thickness of film 121 may be between 0.01 to 10 mm.

In some embodiments, adhesive substance 300 (shown in FIG. 1A) may be a cyanoacrylate-based adhesive substance.

As known in the prior art, traditional practice is to fix fresh-cut coral fragments (e.g., coral fragment 200) on a substrate (like ceramic plates or plugs) using various adhesives, e.g., cyanoacrylate-based adhesives (also known as “super glue”) or epoxy-based ones. After the coral fragment is healed, grown and ready to be transferred or mounted to place of its constant habitat within the tank or within the natural environment, in case of using known substrates and devices for growing corals (e.g., ceramic plates or plugs), it is impossible to detach the coral fragment from the surface without traumatizing or damaging it. Hence, for said purpose, grown coral fragments are either cut off the substrate or glued to the place of constant habitat together with the substrate. However, both options have certain drawbacks. Cutting the grown coral fragment off the substrate traumatizes it, thereby slowing down the further growth (since the fragment needs time to heal) and making it harder for the fragment to survive and adapt to the new habitat. Gluing the coral fragment to the place of its constant habitat together with the substrate is undesirable mostly for aesthetical reasons, since having artificially made plate or plug glued to the natural environment (like a live rock) may ruin natural look of the entire coral composition.

The claimed invention addresses the abovementioned drawbacks of the prior art in the following way. Combination of indicated herein materials of film 121 and adhesive substance 300 provides adhesion which, on the one hand, is strong enough to maintain coral fragment 200 attached to the substrate in the required conditions (light, temperature, water flows, water salinity etc.) as long as it is required, and on the other hand, is weak enough to make it able to easily detach coral fragment 200 together with adhesive substance 300 from film 121 (and substrate 120 itself) without damaging fragment 200, when needed. As was approved by the conducted tests, it is enough to pull coral fragment 200 to either side and it will easily detach from the film together with the layer of adhesive substance 300. Hence, there is no need to repeatedly damage healed and grown coral fragment 200 by cutting it off the substrate and there is no need to ruin aesthetical composition by gluing fragment 200 together with the artificial substrate to the place of its constant natural habitat.

Therefore, the claimed invention further contributes to the abovementioned improvement of the field of coral aquaculture, in particular by reducing time required for healing and growing of coral fragments.

It shall be understood that it is preferred that the size of coral fragment 200 and the layer of adhesive substance 300 are such that they do not cover all of openings 122 and, thereby, do not obstruct the circulation of water from one side of substrate 120 (and film 121) to another.

Furthermore, it shall be understood that reasonable balance between the total area covered by openings 122 (referred herein as “open area”) and the total area of film 121 (and substrate 120) shall be used to keep on the one hand the sufficient rigidity of substrate 120, and on the other hand, to provide the required water circulation.

Hence, in some embodiments, film 121 (and substrate 120 itself) may include at least 5% open area. More specifically, film 121 (and substrate 120 itself) may include 5-50% open area. Yet more specifically, film 121 (and substrate 120 itself) may include 10-40% open area.

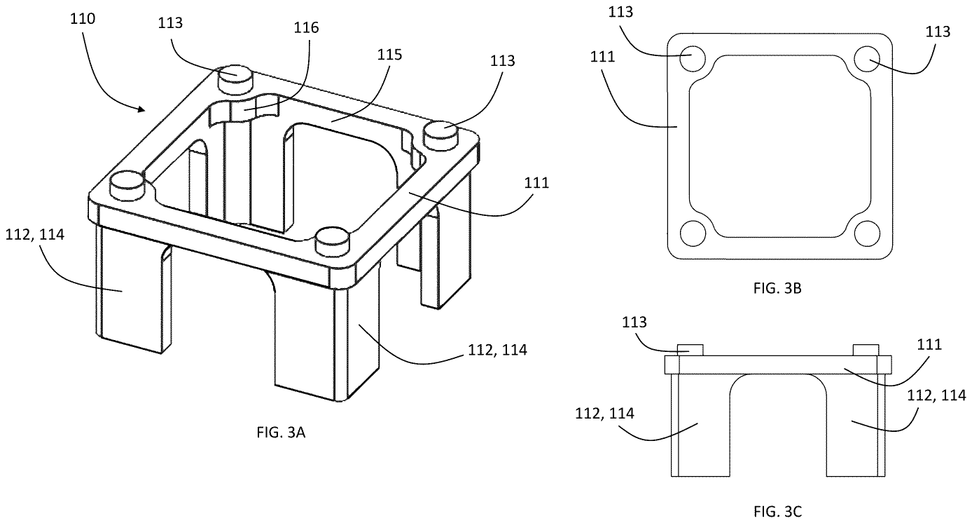

In some embodiments, substrate 120 may be detachably connectable to base 110. In particular, in some embodiments, substrate 120 (and film 121 respectively) may be made with mounting openings 123 which are configured so as to tightly fit respective cylindrical projections 113 (shown in FIGS. 3A-3C) extending normally outwardly from frame 111.

Reference is now made to FIGS. 3A-3C depicting an isometric view, a top view and a side view of base 110 of coral growing device 100, respectively.

In some embodiments, base 110 may be configured to allow passage of fluids from one side of film 121 to another side of film 121, through openings 122 in film 121. In order to allow said passage of fluids, base 110 include frame portion 111, which has large open area in the middle and which is configured to accommodate substrate 120, and support portion 112, wherein support portion includes a plurality of legs 114, for supporting frame portion 111 and accommodated substrate 120. The open area between legs 114 also allows required circulation of fluids to be unobstructed.

Frame portion 111 may include cylindrical projections 113 extending normally outwardly from frame 111, to accommodate substrate 120.

Coral growing device 100, in particular, base 110 may include at least one connector for connecting device 100 to at least one other coral growing device 100, thereby forming rigid matrix-like structure for growing plurality of coral fragments 200 at the same time.

Alternatively, legs 114 may be configured so as to be able to attach to any specific coral frag rack known in the art.

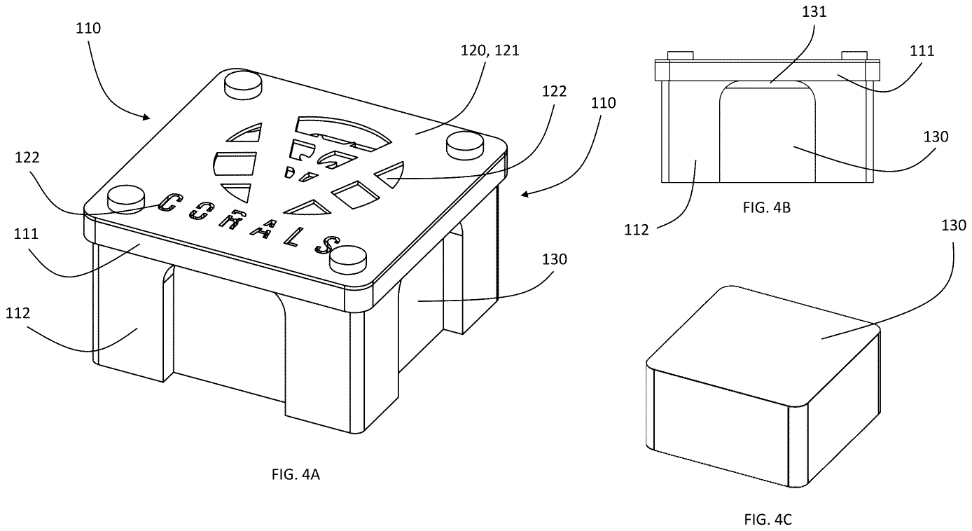

Reference know is made to FIGS. 4A-4C depicting an isometric view and a side view of coral growing device 100 including weight element 130 connected to base 110 and an isometric view of weight element 130 itself, accordingly.

In some embodiments, weight element 130 may be made in the form of a hollow body of generally rectangular parallelopiped shape. In some embodiments, weight element 130 may be made of plastic. In some embodiments, weight element 130 may be filled with suitable material (e.g., sand) so as to have weight comparatively higher than total weight of base 110, substrate 120 and fragment 200. In some embodiments, weight element 130 may have weight sufficient to prevent buoyancy of coral growing device 100 when immersed in seawater (e.g., saltwater having average density at the surface about 1.025 kg/L).

In some embodiments, base 110 may be configured to accommodate weight element 130. In some embodiments, weight element 130 may be connected to base 110 so as to allow passage of fluids from one side of film 121 to another side of film 121, through openings 122 in film 121. In some embodiments, said passage of fluids is achieved by providing a gap between weight element 130 and substrate 120.

In particular, base 110 may include corner portions 116 (shown in FIG. 3A) which extend inwardly and have height higher than height of side portions 115 (shown in FIG. 3A). In this way, weight element 130, when connected to base 110, will abut corner portions 116, thus preventing the complete closure of the open area between legs 114 and maintaining gap 131, thereby allowing passage of fluids from one side of film 121 to another side of film 121.

It shall be understood that the present invention is not limited to any specific form of weight element 130 and any specific way of connecting weight element 130 to base 110, as long as weight element 130 (a) prevents buoyancy of coral growing device 100, thereby keeping coral growing device 100 stably supported by legs 114 under water (e.g., at the bottom of the growth container); and (b) does not obstruct the circulation of fluids from one side of film 121 to another side of film 121, through openings 122 in film 121.

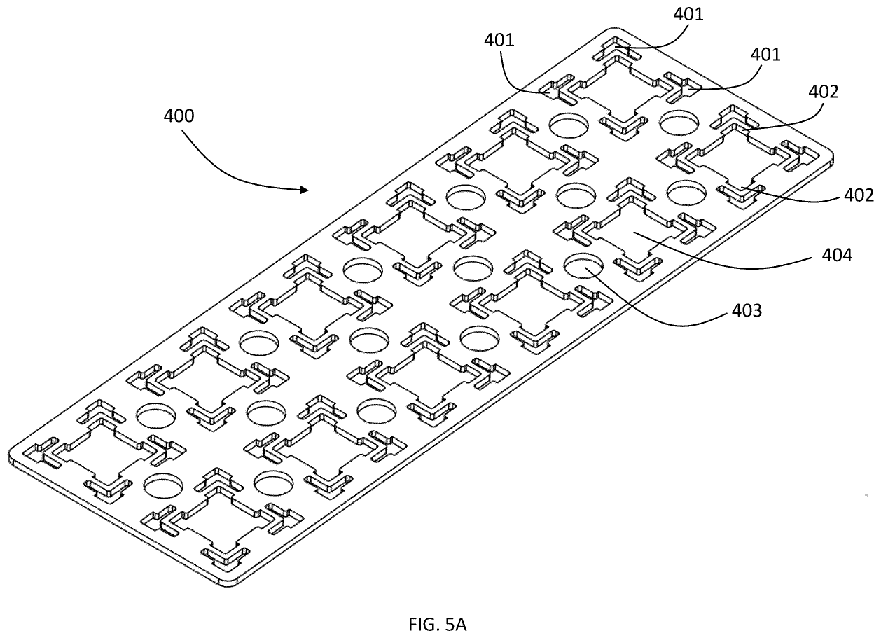

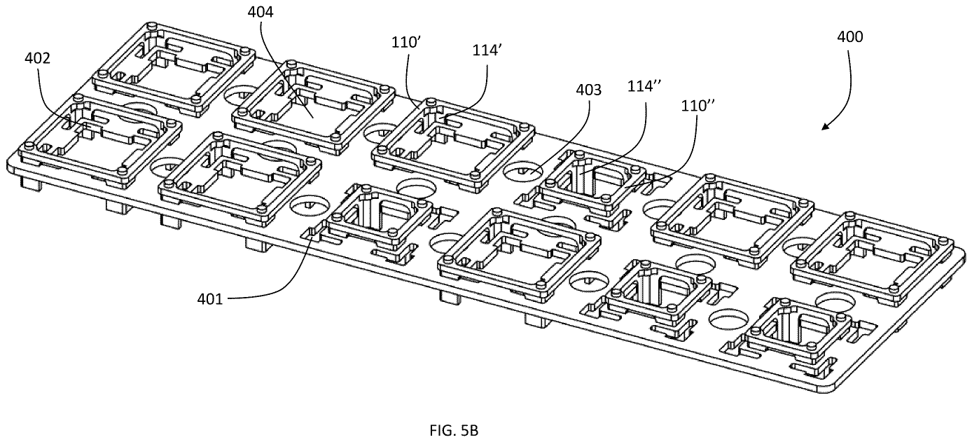

Reference is now made to FIGS. 5A and 5B, which are an isometric view of a coral frag rack 400, configured to accommodate coral growing devices 100 of various sizes; and an isometric view of coral frag rack 400 having attached bases 110′ and 110″ of coral growing devices 100 of various sizes, according to some embodiments.

It should be mentioned in addition that the suggested invention, in particular, the configuration of base 110 and substrate 120, is made such as to allow manufacturing coral growing devices 100 in wide range of sizes (e.g., from 3×3 to 10×10 cm). In contrast to the claimed invention, the size of traditional ceramic plugs is more limited by manufacturing constraints. Traditional ceramic disks or plates are made larger than ceramic plugs, but they do not have any fixation means to be securely attached to the rack. Consequently, they tend to slide around the surface of the rack, which is undesirable since it may affect healing and growth of the coral frag (such as, e.g., coral frag 200) and, moreover, the frag can be accidentally damaged.

Therefore, the present invention provides an additional improvement of the technological field of coral aquaculture, by increasing the possible range of sizes of coral growing devices 100, while keeping the ability to be securely fixed in the growing container (e.g., by attaching legs 114 to the frag rack or by using weight element 130, as described with reference to FIGS. 4A-4C).

As mentioned above, base 110 (in particular, legs 114) may be configured to be attached to any specific coral frag rack known in the art, e.g., racks having grid-like structure. Standard grid-like structures have square openings, formed by intersecting longitudinal and transverse elements. Consequently, if such a coral frag rack is used, the attached coral growing device 100 may have intersecting longitudinal and transverse elements under substrate 120.

Such a configuration is undesirable because it provides more surface under substrate 120 for unwanted algae and creatures to settle. Unwanted algae and creatures may compete with corals over elements in water and in the environment, thereby affecting the healing and growth of coral frags. Moreover, having intersected longitudinal and transverse elements under substrate 120 may affect its flexibility, which is likewise undesirable.

Hence, in some embodiments, specifically designed coral frag rack 400 is provided, as shown in FIGS. 5A and 5B.

Coral frag rack 400 may be configured to accommodate various numbers of coral growing devices 100. E.g., in the illustrated embodiment, coral frag rack 400 has two rows, each including six sets of mounting slots 401 and 402. Mounting slots 401 and 402 are configured to accommodate legs 114 of bases 110 of coral growing devices 100, thereby providing secure fixation thereof.

In the illustrated embodiment, coral frag rack 400 is configured to accommodate coral growing devices 100 of two sizes. Coral growing device 100 of a larger size, e.g., having base 110′, may be mounted on coral frag rack 400 by inserting legs 114′ of base 110′ in mounting slots 401. Coral growing device 100 of a smaller size, e.g., having base 110″, may be mounted on coral frag rack 400 by inserting legs 114″ of base 110″ in mounting slots 402.

As can be seen in the provided embodiment, regardless of the size of coral growing device 100 (and of respective size of base 110′ or 110″), there are no undesired elements located under substrate 120 (substrate 120 itself is not shown in FIGS. 5A and 5B, in order not to obscure other illustrated elements discussed herein). In contrast to standard grid-like coral frag racks, coral frag rack 400 is made with openings 404 right under substrate 120, thereby providing more space for unobstructed water flow circulation (including circulation through openings 122 in film 121, as discussed, e.g., with reference to FIGS. 2A and 2B) and avoiding settlement of unwanted algae and creatures in said area.

In some embodiments, coral frag rack 400 may be made with additional openings 403, thereby further negating the obstruction of water circulation in the growth container.

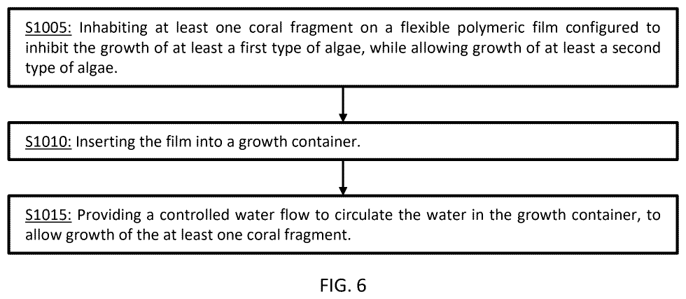

Reference is now made to FIG. 6, depicting a flow diagram of a method of growing corals, according to some embodiments.

As shown in step S1005, the claimed method may include inhabiting at least one coral fragment (e.g., coral fragment 200, as shown in FIG. 1A) on flexible polymeric film (e.g., flexible polymeric film 121, as shown in FIGS. 1A-1B, 2A-2B, 3A-3C and 4A-4C) configured to inhibit the growth of at least a first type of algae (e.g., Bryopsis plumosa and Bacillariophyta), while allowing growth of at least a second type of algae (e.g., Coralline algae). Step S1005 may be carried out by using film 121 having surface roughness of between 0.0015 to 0.007 mm (as described with reference to FIGS. 2A-2B). In some embodiments of the claimed method, inhabiting the at least one coral fragment (e.g., coral fragment 200, as shown in FIG. 1A) on the film (e.g., film 121, as shown in FIGS. 1A-1B, 2A-2B, 3A-3C and 4A-4C) may include fixing the at least one coral fragment on the film using an adhesive substance (e.g., adhesive substance 300, as shown in FIG. 1A).

As shown in step S1010, the claimed method may further include inserting the film into a growth container (also referred herein as aquarium or tank). In some embodiments, growth container may be filled with seawater of desired composition, equipped with a required lighting system and water flow controlling system, as commonly used in solutions known in the art. Step S1010 may be carried out by installing device 100 including film 121 (wherein film 121 is accommodated on frame portion 111 of base 110 which is connected to weight element 130) under the water (as described with reference to FIGS. 1A-1B, 2A-2B, 3A-3C and 4A-4C).

As shown in step S1015, the claimed method may further include providing a controlled water flow to circulate the water in the growth container, to allow growth of the at least one coral fragment (e.g., coral fragment 200, as shown in FIG. 1A). Step S1015 may be carried out by water flow controlling system of the growth container, as known in the art, wherein providing the controlled water flow includes providing the water flow via one or more openings in the film (e.g., openings 122 in film 121, as shown in FIGS. 2A-2B).

In some embodiments, the claimed method may further include harvesting the at least one coral fragment (e.g., coral fragment 200, as shown in FIG. 1A) by fully detaching the at least one coral fragment from the film (e.g., film 121, as shown in FIGS. 1A-1B, 2A-2B, 3A-3C and 4A-4C) without leaving any portion of the at least one coral fragment on the film. Said detaching may be provided by using the film (e.g., film 121) made of the abovementioned materials and by using adhesive substance of abovementioned composition (as described with reference to FIGS. 2A-2B).

As can be seen from the provided description, the claimed invention represents substrate, device and method of growing corals, which provide an improvement of the technological field of coral aquaculture by simplifying and increasing efficiency of the process of controlling presence and population of algae in the coral propagation aquarium, thereby reducing time required for healing and growing new coral fragments.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A substrate for growing coral fragments, comprising:
a flexible polymeric film, wherein said film is made with one or more openings and is configured to inhibit the growth of at least a first type of algae, while allowing growth of at least a second type of algae.

2. The substrate of claim 1, wherein the substrate is detachably connectable to a support.

3. The substrate of claim 2, wherein the film comprises at least 5% open area.

4. The substrate of claim 3, wherein the film comprises 5-50% open area.

5. The substrate of claim 4, wherein the film comprises 10-40% open area.

6. The substrate of claim 1, wherein the film is made of a polymer selected from a list consisting of: acrylonitrile butadiene styrene (ABS); polystyrene (PS); polypropylene (PP); polyethylene (PE); polyethylene terephthalate (PET); polyethylene terephthalate glycol (PET-G); polymethyl methacrylate (PMMA); and silicon.

7. The substrate of claim 1, wherein the thickness of the film is between 0.01 to 10 mm.

8. The substrate of claim 1, wherein the film has a surface roughness of between 0.0015 to 0.007 mm.

9. The substrate of claim 1, wherein the first type of algae is at least one of Bryopsis plumosa and Bacillariophyta.

10. The substrate of claim 1, wherein the second type of algae is Coralline algae.

11. A coral growing device, comprising:
a base comprising a frame portion, and a support portion; and
a substrate comprising a flexible polymeric film, detachably connectable to the base,
wherein the frame portion is configured to accommodate the substrate, and
wherein the support portion comprises a plurality of legs, for supporting the frame and the accommodated substrate.

12. The coral growing device of claim 11, wherein
said film is configured to inhibit the growth of at least a first type of algae, while allowing growth of at least a second type of algae.

13. The coral growing device of claim 12, wherein the film is made with one or more openings.

14. The coral growing device of claim 13, wherein the film comprises at least 5% open area.

15. The coral growing device of claim 14, wherein the film comprises 5-50% open area.

16. The coral growing device of claim 15, wherein the film comprises 10-40% open area.

17.-22. (canceled)

23. The coral growing device of claim 11, further comprising at least one connector for connecting the device to at least one other coral growing device.

24. The coral growing device of claim 11, further comprising a weight element connected to the base, wherein said weight element has weight sufficient to prevent buoyancy of the coral growing device when immersed in a seawater.

25. The coral growing device of claim 24, wherein the weight element is connected to the base so as to allow passage of fluids from one side of the film to another side of the film, through the one or more openings in the film.

26. A method of growing corals, comprising:
inhabiting at least one coral fragment on a flexible polymeric film configured to inhibit the growth of at least a first type of algae, while allowing growth of at least a second type of algae;
inserting the film into a growth container; and
providing a controlled water flow to circulate the water in the growth container, to allow growth of the at least one coral fragment.

27.-38. (canceled)
